(19) United States
(12) Patent Application Publication
(10) Pub. No.: US 2017/0249340 A1
(43) Pub. Date: Aug. 31, 2017

(54) IMAGE CLUSTERING SYSTEM, IMAGE CLUSTERING METHOD, NON-TRANSITORY STORAGE MEDIUM STORING THEREON COMPUTER-READABLE IMAGE CLUSTERING PROGRAM, AND COMMUNITY STRUCTURE DETECTION SYSTEM

(71) Applicant: NATIONAL INSTITUTE OF INFORMATION AND COMMUNICATIONS TECHNOLOGY, Tokyo (JP)

(72) Inventors: Makoto OKUDA, Koganei-shi (JP); Shinichi SATOH, Koganei-shi (JP); Shoichiro IWASAWA, Koganei-shi (JP); Shunsuke YOSHIDA, Koganei-shi (JP); Yutaka KIDAWARA, Koganei-shi (JP)

(73) Assignee: NATIONAL INSTITUTE OF INFORMATION AND COMMUNICATIONS TECHNOLOGY, Tokyo (JP)

(21) Appl. No.: 15/441,453

(22) Filed: Feb. 24, 2017

(30) Foreign Application Priority Data
Feb. 26, 2016 (JP) 2016-035704

(51) Int. Cl. G06F 17/30; G06K 9/62

(52) U.S. Cl. CPC G06F 17/30268; G06K 9/6218; G06K 9/6212; G06F 17/30958; G06F 17/30256

(57) ABSTRACT

Provided is a significantly versatile, novel community structure detection method. An image clustering system includes an obtaining module configured to obtain a match graph reflecting a result of an image matching process of matching input images included in an input image group. The match graph includes a vertex corresponding to each of input images, and an edge which connects vertices corresponding to input images determined to match each other. The image clustering system further includes: a community structure detection module configured to associate input images with each other, based on the match graph's structure; and an output module configured to output as a cluster a set of mutually associated input images.

### BACKGROUND OF THE INVENTION

Field of the Invention

The present invention relates to an image clustering system which clusters a set of input images, an image clustering method, a non-transitory storage medium storing thereon a computer-readable image clustering program, and a community structure detection system suitable for the clustering.

Description of the Background Art

In recent years, as information and telecommunications technology advances, a technique of community structure detection which is a technique of clustering a plurality of elements is applied to various fields. For example, in social media, community structure detection is applied to a graph expressing a user's connection to provide such a service as recommending a friend, or in an EC (electronic commerce) site, community structure detection is applied to a graph expressing a relationship of goods based on a purchase history to provide data mining, such a service as recommending goods, etc.

As a specific solution technique of such community structure detection, for example, “Community detection in graphs,” S. Fortunato, Physics Reports, Vol. 486, pp. 75-174, 2010 introduces a concept of “modularity” which indicates “how larger an edge density in a community is than an edge density obtained by chance” and discloses an approach to maximize an index which is a Q representing the modularity in magnitude. Furthermore, “Building Rome in a day,” Sameer Agarwal, Noah Snavely, Ian Simon, Steven M. Seitz, Richard Szeliski, Proceedings of IEEE International Conference on Computer Vision, 2009 discloses a configuration which utilizes a match graph in order to reconstruct a 3D geometry.

### SUMMARY OF THE INVENTION

The technique of the community structure detection disclosed in the “Community detection in graphs” has such an issue that it is difficult to adjust a range of clustering, i.e., a degree of connection in a community to be detected, as desired. Furthermore, the “Building Rome in a day” does not at all consider application to image clustering for a large number of images. Accordingly, there is a need for a significantly versatile, novel community structure detection method.

An image clustering system according to an embodiment comprises an obtaining module configured to obtain a match graph reflecting a result of an image matching process of matching input images included in an input image group. The match graph includes a vertex corresponding to each of input images and an edge connecting vertices corresponding to input images determined to match each other. The image clustering system further comprises: a community structure detection module configured to associate input images with each other, based on the match graph's structure; and an output module configured to output as a cluster a set of the associated input images.

The community structure detection module may include: a trial module configured to set each vertex included in the match graph as a starting point and make a successive movement within the match graph by a prescribed number of steps while stochastically selecting a connected edge, to obtain a passage history regarding the movement; and an association module configured to determine passage histories associated with each other based on a similarity among the obtained passage histories in which each vertex is set as the starting point, and associate input images with each other which respectively correspond to the starting points of the associated passage histories.

The trial module may repeat the successive movement within the match graph by a prescribed number of steps, with a single vertex serving as a starting point, a prescribed trial number of times. The community structure detection module may further include an exclusion module configured to exclude a vertex having a statistical abnormal value from a plurality of passage histories in which the same vertex is set as the starting point.

The exclusion module may couple together a plurality of passage histories in which the same vertex is set as the starting point and regard a vertex in the coupled passage histories having a relatively small passage frequency such that the vertex is not included in the passage histories.

In the image matching process, in response to determination that a first input image serving as a reference image and a second input image serving as a target image match in the image matching process, in the match graph, an edge may be provided from a vertex corresponding to the first input image toward a vertex corresponding to the second input image.

When a vertex without an edge allowing the movement to another vertex is reached before the movement by the prescribed number of steps is completed, the trial module may terminate a process for obtaining the passage history.

The image clustering system may further comprise an image matching module configured to perform as the image matching process a process to search for a corresponding feature point between input images.

The match graph may have an edge weighted in accordance with a degree of connection between two vertices connected thereby, and the trial module may reflect a weight provided to each selectable edge and then stochastically determine an edge to be followed for a further movement.

The image clustering system may further comprise a searching module configured such that upon externally receiving an image which is a target of a query, the searching module searches through a set of input images included in each cluster for an input image corresponding to the received image and responds with information of a cluster to which the corresponding input image belongs.

An image clustering method according to an embodiment comprises obtaining a match graph reflecting a result of an image matching process of matching input images included in an input image group. The match graph includes a vertex corresponding to each of input images, and an edge connecting vertices corresponding to input images determined to match each other. The image clustering method further comprises: associating input images with each other, based on the match graph's structure; and outputting as a cluster a set of the associated input images.

According to an embodiment a non-transitory storage medium storing thereon a computer-readable image clustering program is provided, the image clustering program causing a computer to perform: obtaining a match graph reflecting a result of an image matching process of matching input images included in an input image group. The match graph includes a vertex corresponding to each of input images, and an edge connecting vertices corresponding to input images determined to match each other. The image clustering program further causes the computer to perform: associating input images with each other, based on the match graph's structure; and outputting as a cluster a set of the associated input images.

A community structure detection method according to an embodiment comprises: an obtaining module configured to obtain a graph including a plurality of vertices and an edge connecting vertices; a trial module configured to set each vertex included in the graph as a starting point and make a successive movement within the graph by a prescribed number of steps while stochastically selecting a connected edge, to obtain a passage history regarding the movement; an association module configured to determine passage histories associated with each other based on a similarity among the obtained passage histories in which each vertex is set as a starting point, and associate vertices that are set as the starting points of the associated passage histories; and an output module configured to output as a cluster a set of the associated vertices.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram for illustrating an image clustering method in which a community structure detection method according to a present embodiment is applied.

FIG. 2 is a flowchart which indicates a general processing procedure of image clustering according to the present embodiment.

FIG. 3 is a schematic diagram indicating an example of a hardware configuration of a clustering system according to the present embodiment.

FIG. 4 is a schematic diagram showing an example of a software configuration of the clustering system according to the present embodiment.

FIGS. 5A and 5B are schematic diagrams showing an example of a match graph generated by the clustering system according to the present embodiment.

FIGS. 6A and 6B are schematic diagrams showing an example of a result of an image matching process in the clustering system according to the present embodiment.

FIG. 7 shows an example of a result of an image matching process corresponding to the match graph shown in FIGS. 5A and 5B.

FIGS. 8A and 8B show an example of passed vertices when a random walk is performed for the match graph shown in FIGS. 5A and 5B.

FIG. 9 is a flowchart of a process indicated in step S8 of FIG. 2 for evaluating a degree of matching between input images.

FIG. 10 is a figure for illustrating a process indicated in step S84 of FIG. 9 for excluding a vertex having an abnormal value.

FIGS. 11A-11C show an example of a result of an experiment for an evaluation in performance of the community structure detection method according to the present embodiment.

FIG. 12 is a schematic diagram representing an example in configuration of an automatic labeling system using the community structure detection method according to the present embodiment.

FIG. 13 is a schematic diagram representing an example in configuration of an image searching system using the community structure detection method according to the present embodiment.

### DESCRIPTION OF THE PREFERRED EMBODIMENTS

The present invention will now be described in an embodiment hereinafter in detail with reference to the drawings. Note that in the figures, identical or corresponding components are identically denoted, and will not be described repeatedly.

### A. Overview

Initially, a community structure detection method according to a present embodiment, and image clustering adapting the community structure detection method will be overviewed.

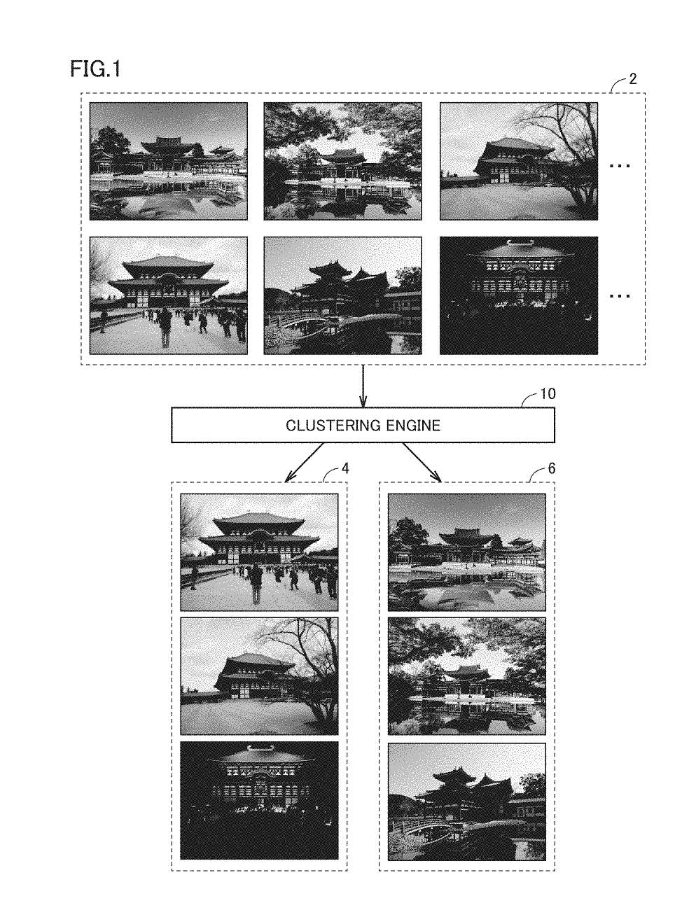

With reference to FIG. 1, an image clustering method in which the community structure detection method according to the present embodiment is applied will be described. When an input image group 2 which is composed of a plurality of input images is input to a clustering engine 10 which implements the community structure detection method according to the present embodiment, input images included in input image group 2 are clustered based on the images' contents and a result thereof is output.

In the example shown in FIG. 1, it is assumed that input image group 2 includes three input images of the Great Buddha Hall of Todai-ji Temple obtained under different photographing conditions (e.g., a different season, a different time zone, a different perspective, a different angle, etc.), and three input images of the Phoenix Hall of Byodoin Temple obtained under different photographing conditions. When these input image groups 2 are input to clustering engine 10, they are separated into a cluster 4 of input images related to the Great Buddha Hall of Todai-ji Temple and a cluster 6 of input images related to the Phoenix Hall of Byodoin Temple.

As shown in FIG. 1, by applying the community structure detection method according to the present embodiment to an input image group, from a plurality of input images a subset of images of identical subjects photographed under different photographing conditions can be extracted. While FIG. 1 shows an exemplary process in a case of clustering a plurality of images for the sake of convenience for description, this is not exclusive and any elements can be clustered. Hereinafter, however, a process in a case of clustering a plurality of images will be described for the sake of convenience for description.

While generally, “clustering” and “community structure detection” may be used synonymously, in the present specification mainly the term “community structure detection” is used to mean a process for searching for elements which belong to the same community in a match graph described later, and the term “clustering” is used to mean a process for sorting from a set of input elements (in the present embodiment, images) into a subset based on some index.

### B. General Processing Procedure

Hereinafter, a procedure of an image clustering process adapting the community structure detection method according to the present embodiment will be described.

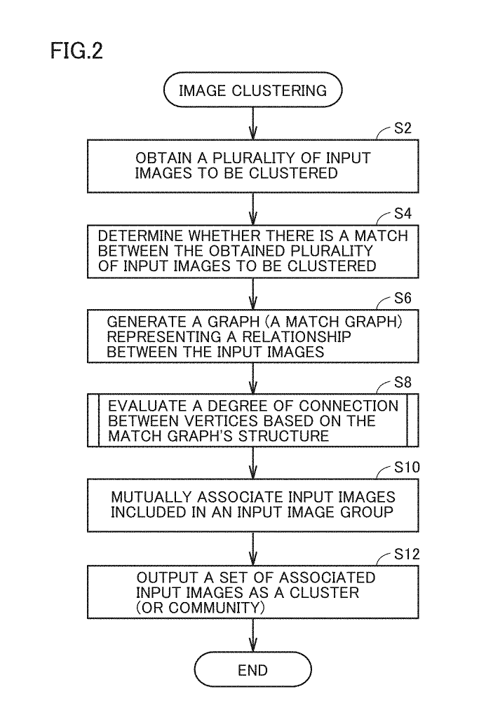

FIG. 2 is a flowchart which indicates a general processing procedure of image clustering according to the present embodiment. Each step shown in FIG. 2 is implemented when an information processor executes a program, as will be described later. With reference to FIG. 2, a process to obtain a plurality of input images to be clustered is performed (step S2). Subsequently, a process to determine whether there is a match between the obtained plurality of input images to be clustered is performed (step S4), and based on a result of having performed the process, a process is performed to generate a graph which shows a relationship between the input images (hereafter also referred to as a “match graph”) (step S6). As an example of a process to evaluate whether there is a match, in the present embodiment any image matching method can be used.

In such steps S2-S6, a match graph reflecting a result of a process of matching input images included in an input image group is obtained. The match graph includes a vertex corresponding to each of input images, and an edge which connects vertices corresponding to input images determined to match each other. The match graph will more specifically be described later. Note that steps S2-S6 may be performed in an external device and a match graph alone may be obtained from the external device.

The generated match graph is subjected to a community structure detection process which detects a community included therein. More specifically, a process is performed to evaluate a degree of connection between vertices (in this case, a degree of matching between each input image and another input image) based on a structure of the match graph (step S8). And based on a result of the evaluation of the degree of matching, a process is performed to associate input images included in an input image group with each other (step S10).

As the process to mutually associate vertices (or input images) composing the match graph, any community structure detection method can be used. As such a community structure detection method, for example, a method disclosed in “Statistical mechanics of community detection,” Jorg Reichardt and Stefan Bornholdt, PHYSICAL REVIEW E 74, 016110 2006 (the “Spin glass” method), a method disclosed in “The map equation,” M. Rosvall, D. Axelsson, C. T. Bergstrom, Eur. Phys. J. Special Topics 178, 13-23 (2009) (the “Infomap” method), etc. are referred to. In other words, although a known method can be used as the community structure detection method, in the present embodiment a process will mainly be described that is performed in a case where a “random walk similarity method” is adopted which is a community structure detection method newly invented by the present inventors.

In the random walk similarity method, in step S8, each vertex included in a match graph serves as a starting point and a connected edge is selected stochastically, and in that way a successive movement is made within the match graph by a prescribed number of steps to obtain a passage history regarding the movement. And based on similarities of passage histories with each vertex serving as a starting point, as obtained through a trial of step S8, a process is performed to determine mutually associated passage histories and mutually associate input images respectively corresponding to the starting points of the mutually associated passage histories. The random walk similarity method will more specifically be described later. Note that the random walk similarity method which the present inventors have newly invented can detect a community included not only in a match graph but also in any graph.

Finally, a process is performed to output a set of the associated input images as a cluster (or a community) (step S12). In other words, a set of input images determined to belong to the same community is output as a clustering result. And an image clustering process thus ends.

Based on the output clustering result, an image, a variety of information, etc. may further be searched for.

### C. Hardware Structure of Clustering System

Hereinafter, an example of a hardware configuration of a clustering system for implementing image clustering according to the present embodiment will be described.

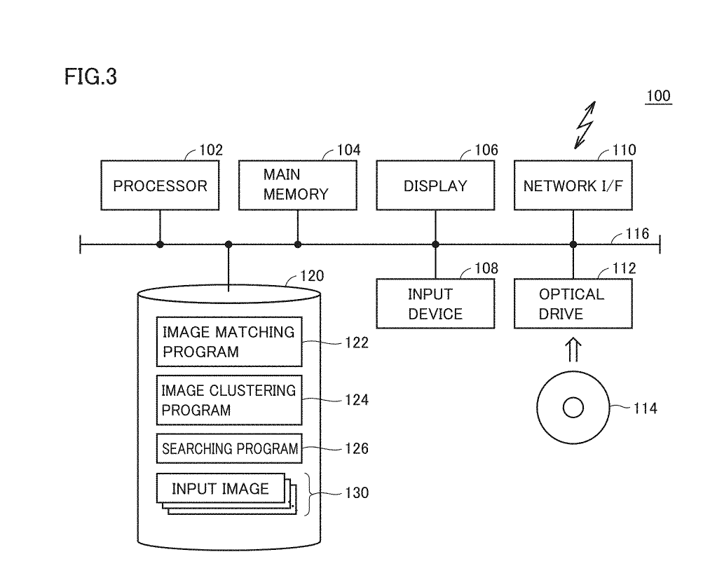

FIG. 3 shows an example of a hardware configuration of a clustering system according to the present embodiment. FIG. 3 shows a clustering system 100 which is typically implemented using a general purpose computer such as a personal computer. More specifically, clustering system 100 includes as main hardware components a processor 102, a main memory 104, a display 106, an input device 108, a network interface (I/F) 110, an optical drive 112, and an auxiliary storage device 120. These components are connected to each other via an internal bus 116.

Processor 102 is a computing entity which executes various programs which will be described later to implement a process required for image clustering according to the present embodiment, and it is composed for example of one or more CPUs (central processing units), GPUs (graphics processing units), etc. A CPU or GPU having a plurality of cores may be used.

Main memory 104 is a storage region to which processor 102 temporarily stores a program code, a work memory, etc. when processor 102 executes a program, and it is composed for example of a volatile memory device etc. such as DRAM (dynamic random access memory) and SRAM (static random access memory).

Display 106 is a display unit which outputs a user interface involved in a process, a processing result, etc., and is composed for example of an LCD (a liquid crystal display), an organic EL (electroluminescence) display, etc. Input device 108 is a device which receives an instruction, an operation, etc. from a user, and is composed for example of a keyboard, a mouse, a touch panel, a pen, etc.

Network interface 110 is a component for communicating data with any information processor etc. on the Internet or an intranet, and any communication system such as the Ethernet (registered trademark), a wireless LAN (a local area network), and Bluetooth (registered trademark) can be used for example.

Optical drive 112 reads information stored in an optical disk 114 such as a CD-ROM (a compact disc read only memory) and a DVD (digital versatile disc) and outputs it to another component via internal bus 116. Optical disk 114 is an example of a non-transitory storage medium, and distributed in a state in which any program is stored thereon in a non-volatile manner. When optical drive 112 reads a program from optical disk 114, and installs it to auxiliary storage device 120 etc., the general purpose computer such as a personal computer functions as clustering system 100. Accordingly, a subject matter of the present invention can also be a program per se installed in auxiliary storage device 120 etc., or a storage medium such as optical disk 114 having a program stored thereon for implementing a process according to the present embodiment.

Although FIG. 3 shows an optical storage medium such as optical disk 114 as an example of a non-transitory storage medium, it is not exclusive and it may be a semiconductor storage medium such as flash memory, a magnetic storage medium such as a hard disk or a storage tape, a magneto-optical storage medium such as MO (magneto-optical disk), etc.

Auxiliary storage device 120 is a component which stores a program executed by processor 102, input data to be processed via the program, and output data generated as the program is executed, etc., and it is composed for example of a nonvolatile storage device such as a hard disk and an SSD (solid state drive). More specifically, auxiliary storage device 120 has typically stored therein an OS (operating system) (not shown) as well as an image matching program 122, an image clustering program 124, a searching program 126, and an input image 130.

Furthermore, a library and a functional module etc. which are required when executing image matching program 122, image clustering program 124 and searching program 126 in processor 102 may partially be substituted using a library or a functional module which the OS provides as a standard. In that case, image clustering program 124 and searching program 126 will each not include all of program modules required to implement image clustering according to the present embodiment, however, by installing them in an environment in which the OS is executed, image clustering according to the present embodiment can be implemented. Even such a program which does not include a portion of a library or functional module can also be included in the scope of the present invention.

Image matching program 122, image clustering program 124 and searching program 126 may not only be stored in any of such storage media as described above, and thus distributed but may also be downloaded from a server device etc. via the Internet or an intranet and thus distributed.

Although FIG. 3 shows an example in which a single information processor configures clustering system 100, this is not exclusive and a plurality of networked information processors may cooperate explicitly or implicitly to implement image clustering according to the present embodiment.

In auxiliary storage device 120, an input image group 130 composed of input images to be clustered may be stored. Alternatively, input image group 130 stored in auxiliary storage device 120 may be stored in one or more server devices on a network.

Furthermore, a function implemented by a computer (processor 102) executing a program may entirely or partially be implemented using a hard-wired circuit such as an integrated circuit. For example it may be implemented using an ASIC (application specific integrated circuit), an FPGA (field-programmable gate array), etc.

A skilled artisan would be able to implement image clustering according to the present embodiment by using as appropriate a technique corresponding to an era when the present invention is implemented.

### D. Software Structure of Clustering System

Hereinafter, an example of a software configuration of the clustering system for implementing image clustering according to the present embodiment will be described.

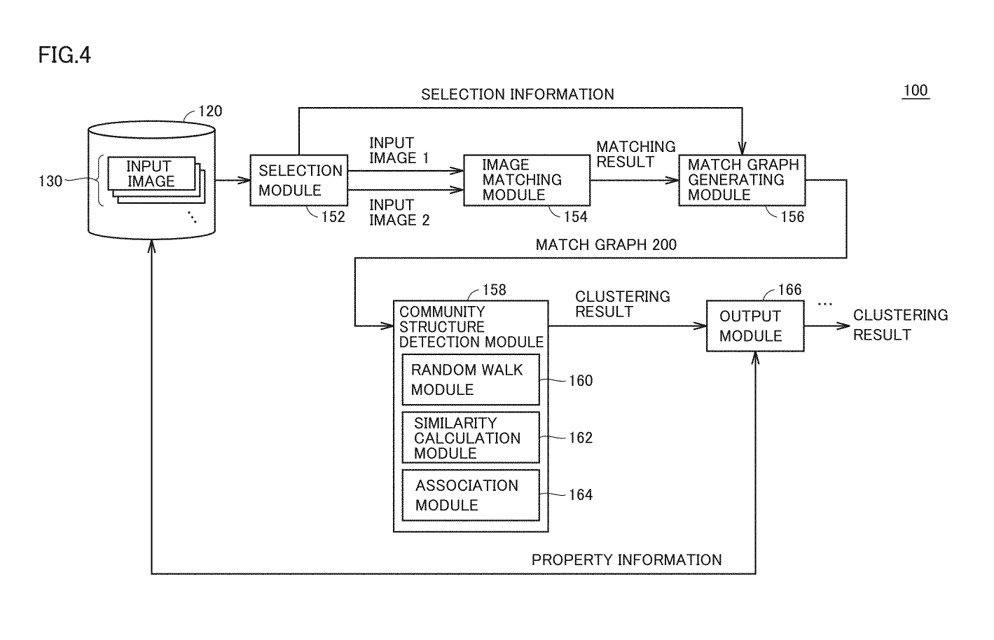

With reference to FIG. 4, clustering system 100 includes as major software components a selection module 152, an image matching module 154, a match graph generating module 156, a community structure detection module 158, and an output module 166. These software components are provided by processor 102 shown in FIG. 3 executing image matching program 122 and image clustering program 124.

Selection module 152 and image matching module 154 evaluate whether any input images match. Specifically, selection module 152 selects any input image included in input image group 130 stored in auxiliary storage device 120 to be clustered and another such image, and provides the images to image matching module 154. Image matching module 154 performs an image matching process between the two input images provided from selection module 152 to perform a process to search for an identical or similar feature point between the input images (i.e., a feature point matching process). Image matching module 154 outputs a result of the feature point matching process between any two input images to match graph generating module 156. Regarding various combinations of input images 130, a process by selection module 152 and image matching module 154 as described above is performed repeatedly.

Based on a result of the feature point matching process from image matching module 154, and information of a set of input images having provided the result of the feature point matching process (i.e., image selection information), match graph generating module 156 generates a match graph 200 which is a graph representing a relationship between the input images.

In the configuration shown in FIG. 4, selection module 152, image matching module 154, and match graph generating module 156 correspond to an obtaining module which obtains match graph 200 reflecting a result of a process of matching input images included in an input image group.

Community structure detection module 158 subjects match graph 200 generated by match graph generating module 156 to the community structure detection method according to the present embodiment to detect a community from elements (i.e., input images) included in match graph 200. More specifically, community structure detection module 158 includes a random walk module 160, a similarity calculation module 162, and an association module 164.

Note that as a configuration alternative to community structure detection module 158, such a module that detects a community by a known community structure detection method may be adopted.

Random walk module 160 provides a trial function to set each vertex included in match graph 200 as a starting point and make a successive movement within match graph 200 by a prescribed number of steps while stochastically selecting a connected edge, to obtain a passage history regarding the movement. Similarity calculation module 162 calculates similarities of passage histories with each vertex serving as a starting point, as obtained by random walk module 160. Based on similarities calculated by similarity calculation module 162, association module 164 determines passage histories associated with each other and associates input images with each other which respectively correspond to the starting points of the associated passage histories.

Output module 166 outputs a set of input images that are mutually associated by community structure detection module 158 as a cluster (or a clustering result). Output module 166 may add attribute information to an input image included in each cluster.

### E. Process for Generating Match Graph

Hereinafter, a process for generating match graph 200 according to the present embodiment will be described.

(e1: Match Graph)

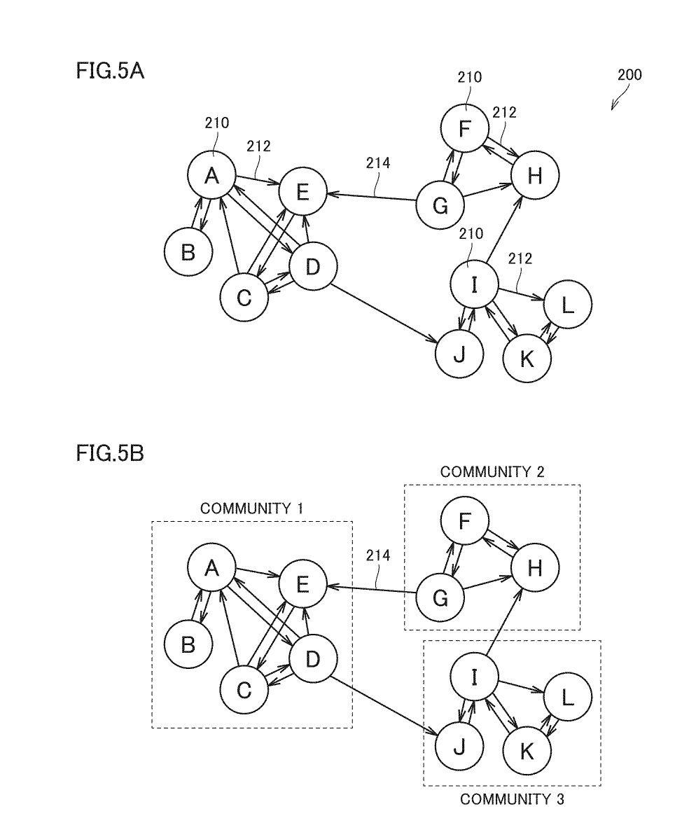

With reference to FIGS. 5A and 5B, an example of match graph 200 generated by clustering system 100 according to the present embodiment will be described. Note that it is not necessary to visualize the match graph shown in FIGS. 5A and 5B per se, and it may be logically generated inside clustering system 100.

With reference to FIG. 5A, match graph 200 is composed of a plurality of vertices 210 and one or more edges 212 indicating whether vertices 210 match. Each vertex 210 corresponds to each of input images to be clustered. More specifically, FIG. 5A shows match graph 200 regarding image A to image L for a total of 12 input images. Each edge 212 represents that (input images respectively indicating) two vertices that the edge connects match.

FIG. 5A shows as one example an example of a directed graph in which edge 212 has information of a direction. In an image clustering system, edge 212 of match graph 200 shows a result of a process of matching input images which two adjacent vertices 210 represent, respectively.

A graph similar to a match graph processed in the community structure detection method and image clustering according to the present embodiment is disclosed in “Building Rome in a day” discussed above. Note, however, that “Building Rome in a day” discussed above only discloses a configuration which utilizes a match graph in order to reconstruct a 3D geometry, and it does not assume at all using it in such image clustering as described in the present embodiment.

However, the present inventors have arrived through a diligent study at a new idea, i.e., that a match graph is applicable to image clustering. More specifically, the present inventors have inferred that a connected component of a match graph is composed mainly of images in which identical subjects are photographed. Accordingly, the present inventors have conducted an experiment using a large quantity of images, and as a result have confronted an issue, i.e., that a connected component composed of images in which mutually different subjects are photographed is created. The present inventors have analyzed the issue, and found that it is caused by a mismatch between images. The present inventors have further proceeded with the analysis and found that a mismatch between images occurs with relatively low frequency and that a connection between images (vertices in a match graph) in which identical subjects are photographed is dense whereas a connection between images (vertices in the match graph) in which different subjects are photographed is sparse. Based on findings as obtained through the experiment, the present inventors have succeeded in applying a community detection method to a match graph to sort a set of densely connected vertices as a community and cluster from each sorted community a set of images in which identical subjects are photographed. Hereinafter, a method for generating a match graph, a community structure detection process for the match graph, etc. will be described.

(e2: Image Matching Method)

As the image matching method, any method can be used. In the present embodiment, as an example, a process to search for a corresponding feature point between input images is adopted as an image matching process. More specifically, a system using a local image feature quantity, etc. is adopted such as described in detail in “Distinctive Image Features from Scale-Invariant Keypoints,” David G. Lowe, Accepted for publication in the International Journal of Computer Vision, 2004. Jan. 5, 2004.

The image matching process is implemented by processor 102 shown in FIG. 3 executing image matching program 122. Furthermore, of the software components shown in FIG. 4, image matching module 154 is responsible for this image matching process.

In the example shown in match graph 200 shown in FIG. 5A, edge 212 is present from vertex A toward vertex E, which means that when an input image A corresponding to vertex A serves as a reference image and an input image E corresponding to vertex E serves as a target image, a corresponding feature point has been found between the images.

In contrast, in the example shown in match graph 200 shown in FIG. 5A, edge 212 is absent from vertex E toward vertex A, which means that when input image E corresponding to vertex E serves as a reference image and input image A corresponding to vertex A serves as a target image, no corresponding feature point has been found between the images.

Thus, in response to determination that a first input image serving as a reference image and a second input image serving as a target image match in the image matching process, in match graph 200, an edge may be provided from a vertex corresponding to the first input image toward a vertex corresponding to the second input image. Adopting match graph 200 which is such a directed graph allows increased clustering accuracy.

While in the above description a directed graph is indicated as an example, the community structure detection method according to the present embodiment is also applicable to an undirected graph in which edge 212 does not have information on direction.

By performing the image matching process for any possible combinations of any two input images included in an input image group to be clustered, such a match graph as shown in FIG. 5A is generated. When observing the match graph visually shown in FIG. 5A, it can be seen implicitly that three communities are included, and clustering system 100 according to the present embodiment implements such clustering in a method as will be described later. More specifically, by applying the community structure detection method according to the present embodiment to match graph 200 as shown in FIG. 5A, a community detection result as shown in FIG. 5B is obtained.

Based on the community detection result as shown in FIG. 5B, input images A-E respectively corresponding to vertices A-E are an input image group (a community 1) in which the same subject is photographed, input images F-H respectively corresponding to vertices F-H are an input image group (a community 2) in which the same subject is photographed, and input images I-L respectively corresponding to vertices I-L are an input image group (a community 3) in which the same subject is photographed.

In match graph 200 shown in FIGS. 5A and 5B, an edge 214 is present from vertex G belonging to community 2 to vertex E which belongs to community 1. This edge 214 means that a mismatch has occurred between input image G corresponding to vertex G and input image E corresponding to vertex E. Although in the image matching process an image mismatch can be caused by an erroneous correspondence between feature points, the community structure detection method according to the present embodiment can also remove such a mismatch at any level.

When the community structure detection method according to the present embodiment is applied to image clustering, a match graph is a graph in which set an input image as a vertex and input images (or vertices) which establish a matching relationship with a feature point extracted from the input image are connected by a directed edge.

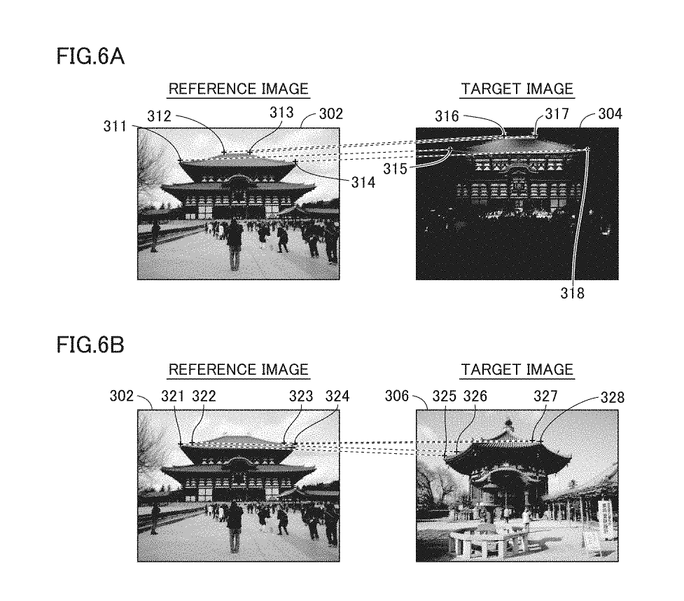

FIGS. 6A and 6B are schematic diagrams showing an example of a result of the image matching process in clustering system 100 according to the present embodiment. FIG. 6A shows an example of a result of performing the image matching process for two input images in which identical subjects are photographed (an appropriate match), and FIG. 6B shows an example of a result of performing the image matching process for two input images in which different subjects are photographed (a mismatch).

As shown in FIG. 6A, a feature point included in an input image 302 set as a reference image and a feature point included in an input image 304 set as a target image are extracted. An example is indicated in which it is determined that, of the feature points extracted from the respective input images, feature points 311-314 extracted from the reference image (or input image 302) match feature points 315-318 extracted from the target image (or input image 304), respectively. Note that, based on a similarity in feature quantity of an extracted feature point etc., a pair of corresponding feature points between input images is extracted and searched for.

In contrast, as shown in FIG. 6B, there is also a case in which it is determined that sets of feature points extracted from input images 302 and 306 obtained by photographing different subjects, respectively, match. In the example shown in FIG. 6B, it is erroneously determined that feature points 321-324 extracted from the reference image (or input image 302) match feature points 325-328 extracted from a target image (or input image 306), respectively.

It is assumed that a connected component of a match graph is composed mainly of input images obtained by mainly photographing identical subjects. However, by mismatching feature points as shown in FIG. 6B, a connected component including input images in which different subjects are photographed can also be generated such as edge 214 which connects different communities, as shown in FIGS. 5A and 5B.

However, when observing on the whole, a possibility of mismatching is low, and a connection of vertices representing input images obtained by photographing identical subjects is dense whereas a connection of vertices representing input images obtained by photographing different subjects is sparse.

By applying the community structure detection method according to the present embodiment to such a connected component, image clustering for each subject can be implemented more reliably. More specifically, an effect of a noise caused by mismatching can be removed at any level by a community structure detection process which will be described later.

FIGS. 5A and 5B show a directed graph as a match graph by way of example. In the figures, each arrow means that let an input image corresponding to a vertex located at a starting point be a reference image and let an input image corresponding to a vertex located at an end point be a target image and when the image matching process is performed in that condition there is a matching feature point between the images. This is because in a case where an image matching method based on a feature point, as disclosed in “Distinctive image features from scale-invariant keypoints,” D. Lowe, International Journal of Computer Vision, Vol. 60, No. 2, pp. 91-110, 2004 is adopted, a feature point matching a feature point of input image A is present in input image B does not necessarily means that the reverse is established.

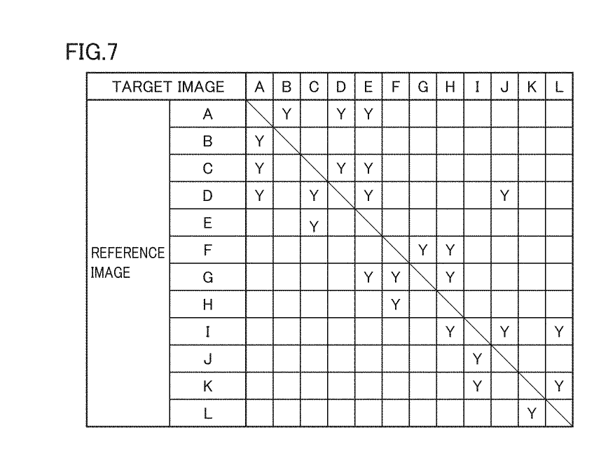

FIG. 7 shows an example of a result of the image matching process corresponding to the match graph shown in FIGS. 5A and 5B. As shown in FIG. 7, clustering system 100 performs the image matching process for any possible combinations of any two input images included in input image group 130 to be clustered. In FIG. 7, “Y” means what there has been found a corresponding feature point between two input images. Based on a result of the image matching process as shown in FIG. 7, a match graph as shown in FIGS. 5A and 5B is generated.

Note that when one of two input images serves as a reference image and the other one serves as a target image and the images are subjected to the image matching process and then the reference image and the target image are switched and the image matching process is again performed, and a corresponding feature point is found in any of the image matching processes, then it may be determined that the images match and an edge may be provided between the vertices representing these input images, respectively.

Furthermore, in a community structure detection method described later, in addition to whether input images match, additional information may further be used such as the number of feature points associated between two input images, the magnitude of the similarity of the associated feature points, and the reliability of the associated feature points. When an image matching method which can calculate such additional information is adopted, these pieces of additional information are also stored together. Such additional information may be reflected as a weight for each edge of the match graph, for example.

(e3: Undirected Graph)

When using an undirected graph, then, in terms of which vertex is connected by an edge, it is preferable to consider such a characteristic of the feature point matching process as described above. For example, a method may be adopted in which let one of two input images be a reference image and let the other one be a target image and only when a corresponding feature point is found therebetween and a corresponding feature point is also found in the reverse case, an edge which connects two vertices respectively corresponding to these two input images is provided.

Alternatively, let one of input images be a reference image, and when a corresponding feature point is found, these two input images may be connected by an edge.

### F. Community Structure Detection Process

Hereinafter, the community structure detection process according to the present embodiment will be described.

(f1: General Process of Community Structure Detection Process)

In the community structure detection process (a random walk similarity method) according to the present embodiment, such a match graph as shown in FIGS. 5A and 5B is subjected to a “random walk” and a community is determined based on a result of performing the random walk. A “random walk” is a process in which a process in which a walker starts at any vertex in a graph and randomly selects one of edges connected to the current vertex (i.e., a selectable edge), and moves to a next vertex along the selected edge, is repeatedly performed a plurality of times. In doing so, in a case by a directed graph, whether the movement can be done is determined with the edge's direction also considered.

When taking the match graph shown in FIGS. 5A and 5B as an example, there are more edges connecting vertices belonging to community 1 than those connecting vertices belonging to community 1 and vertices belonging to other communities. In other words, it can be said that vertices belonging to the same community are connected more densely.

Predicated on such knowledge, when a random walk is performed with a vertex in a graph serving as a starting point, the walker (an entity indicating the current position during the random walk) will stochastically walk for a while around densely connected vertices.

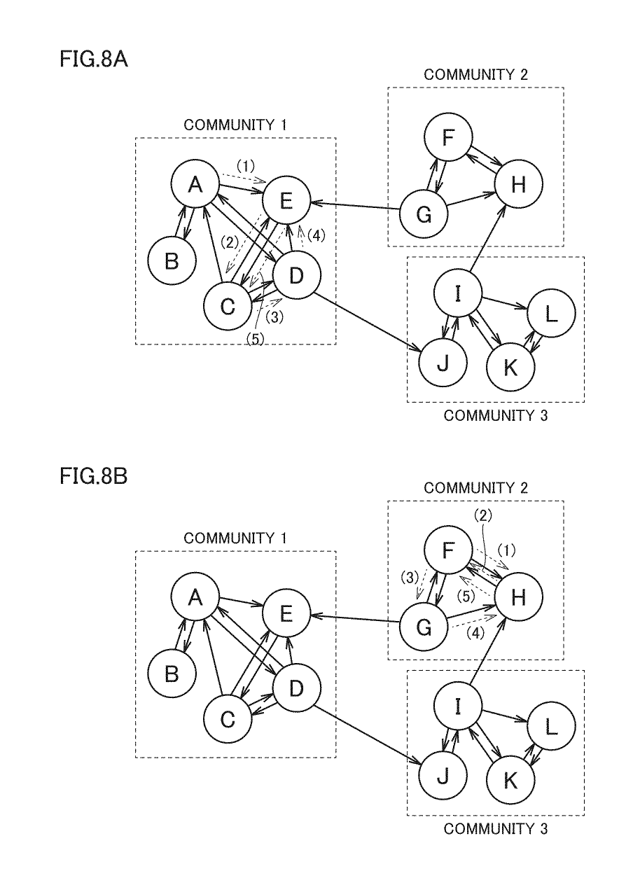

FIGS. 8A and 8B show an example of passed vertices when a random walk is performed for the match graph shown in FIGS. 5A and 5B. FIG. 8A shows an example of passed vertices with vertex A serving as a starting point, and FIG. 8B shows an example of passed vertices with vertex F serving as a starting point. For passed vertices shown in FIGS. 8A and 8B, a parenthesized number indicates a step number in a random walk.

As shown in FIG. 8A, for example in the match graph shown in FIGS. 5A and 5B, there is a high probability that a walker starting from vertex A will walk for a while around vertices A, B, C, D, and E (i.e., vertices belonging to community 1). Similarly, there is a high probability that a walker starting from any of vertices B, C, D, and E will also walk for a while around vertices A, B, C, D, and E (i.e., vertices belonging to community 1). In contrast, for example as shown in FIG. 8B, there is a high probability that a walker starting from any of vertices F-L belonging to other communities will walk around vertices completely different than the walker starting from vertices A-E.

Thus, from each of all of the vertices included in a target graph a random walk is performed by a prescribed number of steps, and starting vertices with similar passed vertices can be regarded as being mutually densely connected.

Based on the present inventors' new findings as described above, in the community structure detection method according to the present embodiment, a match graph is generated and a random walk is performed from each vertex of the generated match graph, and based on a result of performing the random walk (i.e., a set of passed vertices), a group of mutually densely connected vertices is determined. In other words, in the present embodiment, a similarity between vertices is evaluated based on a result of performing a random walk.

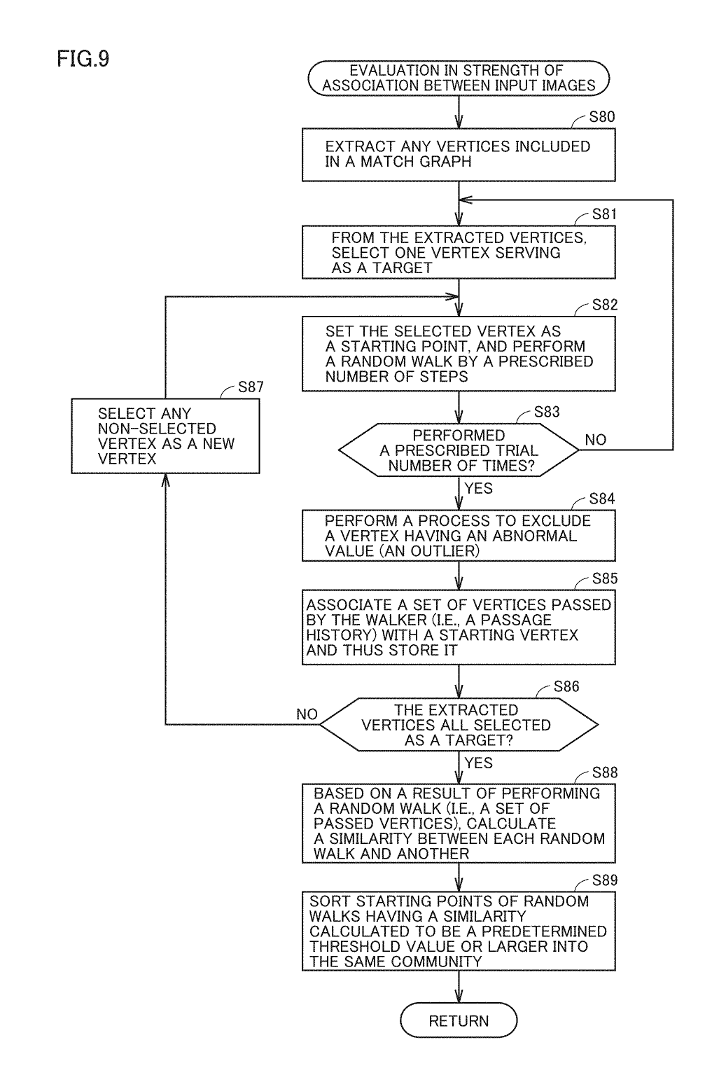

FIG. 9 is a flowchart of a process indicated in step S8 of FIG. 2 for evaluating a degree of matching between input images. With reference to FIG. 9, initially any vertices included in a match graph generated in step S6 of FIG. 2 are extracted (step S80). Subsequently, of the vertices extracted in step S80, one vertex serving as a target is selected (step S81). The selected vertex is set as a starting point, and a random walk is thus performed by a prescribed number of steps (step S82).

Step S82 is repeated a prescribed trial number of times (i.e., while NO is indicated in step S83). In other words, a successive movement within a match graph, with the same vertex serving as a starting point, by a prescribed number of steps is repeated a prescribed trial number of times.

When performing step S82 the prescribed trial number of times ends, a process to exclude a vertex having an abnormal value (an outlier) is performed (step S84), and a set of vertices passed by the walker through the random walk (i.e., a passage history) is associated with a target starting vertex and thus stored (step S85). In other words, a result of performing a random walk will be an association of each starting vertex and one or more vertices passed by a walker with each vertex serving as a starting point.

The prescribed number of steps and the prescribed trial number of times can be set as desired, and for example, the prescribed number of steps can be set to be the same number as that of vertices included in an input match graph and the prescribed trial number of times can be set to “100” for example. Alternatively, the user may be allowed to adjust the prescribed number of steps and/or the prescribed trial number of times interactively with reference to a result of the community structure detection process.

Whether the vertices extracted in step S80 have all been selected as a target is determined (step S86), and if there is any extracted vertex left that is not selected (NO in step S86), the vertex is selected as a new vertex (step S87). And step S82 is repeated.

If the extracted vertices have all been selected as a target (YES in step S86), then, based on a result of performing a random walk for each vertex (i.e., a set of passed vertices), a similarity between each random walk and another is calculated (step S88). And starting points of random walks having a similarity calculated to be a predetermined threshold value or larger are sorted into the same community (step S89). And step S8 ends.

(f2: Application to Directed Graph)

The community structure detection process according to the present embodiment is applicable to both an undirected graph and a directed graph. Note, however, that when it is applied to a directed graph, then, there is a possibility that a walker of a random walk may no longer be able to further move before the walker reaches a designated predetermined number of steps. This applies to a case for example in which the walker has arrived at a vertex where there is no edge allowing the walker to move to another vertex. Accordingly, when the walker has arrived at a vertex with no edge allowing the walker to move to another vertex before the walker completes a movement by the prescribed number of steps, a process for obtaining a passage history (i.e., a random walk) may be terminated.

By adopting such a process, the community structure detection process according to the present embodiment will also be applicable to a directed graph.

(f3: Process for Excluding a Vertex Having Abnormal Value)

Hereinafter, a process in step S84 of FIG. 9 that excludes a vertex having an abnormal value (or outlier) will be described. In the abnormal value exclusion process, a vertex having a statistical abnormal value is excluded from a plurality of passage histories in which the same vertex is set as a starting point. More specifically, of vertices passed by a walker through a random walk for each starting vertex, a vertex passed with a statistically low frequency is excluded as abnormal.

In step S83 of FIG. 9, a random walk is repeated a prescribed trial number of times because doing so ensures statistical stability. For example, if a random walk with each vertex serving as a starting point is each performed only once, there is a possibility that the walker may move to a weakly connected community by a relatively small number of steps. Accordingly, a random walk with each vertex serving as a starting point is performed repeatedly a prescribed trial number of times (e.g., 100 times). And then, a vertex passed by a movement made to a weakly connected community is excluded as abnormal.

For example, set a set of passed vertices obtained through an n-th tried random walk with a vertex vi as a starting vertex be Sin, where 0<i≦a total number of vertices L, and 1≦n≦a prescribed trial number of times N. Set Sin of passed vertices will include at least a portion of vertices v1, v2, v3, . . . , vL included in a match graph. And a result of performing a random walk with vertex vi serving as a starting vertex will be a sum of sets Sin of passed vertices i.e., a set Si of passed vertices←Si1 ∪Si2 ∪ . . . ∪SiN.

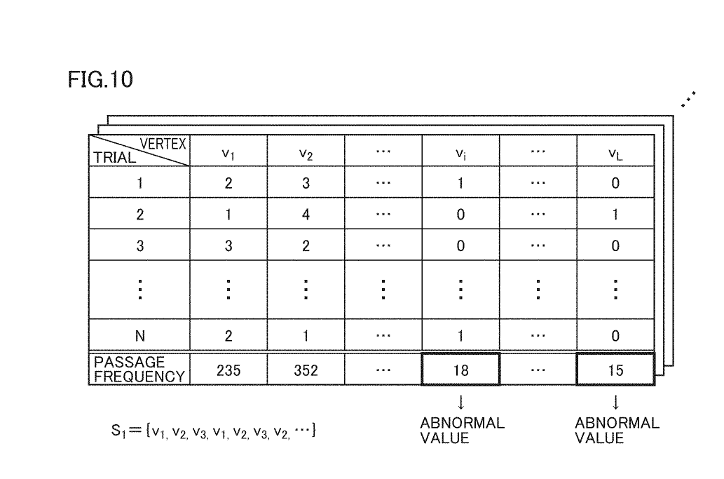

With reference to FIG. 10, the process indicated in step S84 of FIG. 9 for excluding a vertex having an abnormal value will be described. FIG. 10 shows an example of a result of performing a random walk N times with each vertex serving as a starting vertex. In FIG. 10, a result indicated on a frontmost side is with vertex v1 serving as a starting vertex. In FIG. 10, a numerical value indicates how many times each vertex has been passed in a corresponding tried random walk. For example, in a random walk on a first trial with vertex v1 serving as a starting vertex, the walker has passed vertex v2 “3” times (see FIG. 10, column “trial,” field “1”).

Regarding such a prescribed trial number of times, a frequency (or an inclusive sum) of passage of a walker through each vertex is calculated, and when this passage frequency is relatively small, it is excluded as abnormal. Whether it is relatively small can be determined using a predetermined threshold value. The threshold value for determining an abnormal value can be the prescribed trial number of times multiplied by a prescribed ratio (i.e., a fixed value between 0 and 1). As an example, when the prescribed trial number of times is “100,” and the prescribed ratio is set to “0.2,” then, the threshold value for determining an abnormal value will be “20.” In the example shown in FIG. 10, vertex vi and vertex vL are excluded as abnormal. In other words, a vertex where a walker passed a number of times equal to or less than the threshold value may not be regarded as a passage history.

Thus, in the abnormal value exclusion process, a plurality of passage histories in which the same vertex is set as a starting point are coupled together and a vertex in the coupled passage histories having a relatively small passage frequency is regarded as not being included in the passage histories.

As a result, a result of performing a random walk with vertex vi serving as a starting vertex, or set Si of passed vertices, will include vertices v1 and v2 having a relatively large passage frequency and exclude vertices vi and vL.

Alternatively, a set of passed vertices including a vertex determined as not being regarded as a passage history may per se be excluded as abnormal. For example, in the example shown in FIG. 10, vertices vi and vL each have a passage frequency equal to or less than the threshold value, and accordingly, Sets S11, S12 and S1N of passed vertices including vertex vi or vL are excluded as abnormal and a union of any other sets of passed vertices is used to calculate a similarity described later.

Note that the threshold value for excluding a vertex having an abnormal value (or outlier) may not be determined based on the prescribed trial number of times and may instead be determined based on each vertex's passage frequency distribution or the like. For example, it may be set for example to 50% of a median of the passage frequency distribution. That is, a reference for excluding a vertex having an abnormal value may be designed as desired depending on a characteristic of a target population.

(f4: Process for Calculation of Similarity)

Hereinafter will be described some specific methods for calculating a similarity in step S88 of FIG. 9. This similarity is an index indicating between each random walk performed from a starting vertex and another such random walk how their passed vertices are similar. Note that although in the following description a case will be illustrated in which a similarity between two random walks is calculated, a similarity between three or more random walks may be calculated.

(1) Method Using Jaccard Coefficient Between Sets of Passed Vertices

When a set of vertices passed by a walker with vertex vi serving as a starting point is represented as Si and a set of vertices passed by a walker with vertex vj serving as a starting point is represented as Sj, then a Jaccard coefficient serving as a similarity simᵢⱼ can be calculated according to the following expression (1):

$${sim}_{ij} = \frac{\vert {S}_{i} ⋂ {S}_{j} \vert}{\vert {S}_{i} ⋃ {S}_{j} \vert} \qquad ( 1 )$$

In expression (1), Si∪Sj means a set (or union) of any vertices belonging to at least one of sets Si and Sj of passed vertices, and Si∩Sj means a set (or product set) of any vertices belonging to both sets Si and Sj of passed vertices. More specifically, similarity simᵢⱼ represents a ratio of a number of vertices passed by both of two target random walks to a number of vertices passed by either one of the two random walks.

When the above described abnormal value exclusion process is performed, as each set of passed vertices Si and Sj, a set excluding a vertex or a set of passed vertices excluded by the abnormal value exclusion process is used.

A number of sets of passed vertices equal to a number of vertices included in a target match graph are generated, and similarity will be calculated for any possible combinations of any two of the generated sets of passed vertices.

(2) Method Using COS Similarity of Frequency Vector of Passed Vertex

A frequency of passage through each vertex of set S of passed vertices may be regarded as a multi-dimensional vector and similarity between elements in such vectors may indicate a similarity among random walks of interest.

For example, when a walker with vertex v1 serving as a starting point has passed through vertex v1 twice and vertex v2 thrice, . . . and does not pass through vertex vL, a frequency vector f1 which represents each vertex's passage frequency can be defined as (2, 3, . . . , 0). Frequency vector f1 will have an order of L, and can be regarded as a spatial vector of an L-dimensional space. And as a similarity between frequency vectors in the L dimensional space, COS (cosine) (more specifically, a coefficient of correlation between frequency vectors) can be used.

More specifically, when a frequency vector representing a frequency of passage through each vertex by a walker with vertex vi serving as a starting point is represented as fᵢ and a frequency vector representing a frequency of passage through each vertex by a walker with vertex vj serving as a starting point is represented as fⱼ, then a COS similarity cos (fᵢ, fⱼ) can be calculated according to the following expression (2):

$$cos ( {f}_{i} , {f}_{j} ) = \frac{{f}_{i} \cdot {f}_{j}}{\vert {f}_{i} \vert \vert {f}_{j} \vert} \qquad ( 2 )$$

A number of sets of passed vertices equal to a number of vertices included in a target match graph, and frequency vectors corresponding thereto are generated, and as is apparent from expression (2), a COS similarity will be calculated for any possible combinations of any two of the generated frequency vectors.

(3) Others

As the abnormal value exclusion process, one-class SVM (Support Vector Machine) may be used.

For example, when calculating a COS similarity, a frequency vector is generated from a result obtained by repeating a random walk a prescribed trial number of times (e.g., 100 times) with each vertex serving as a start point (i.e., a set of passed vertices). After that, one-class SVM is used to delete a frequency vector of a prescribed ratio (e.g., of 5%) as an exception, and after that, from the remaining vector group a single vector may be selected randomly and the selected vector may be regarded as a representative frequency vector for that starting vertex.

A similar procedure is also applicable to a process for calculating a Jaccard coefficient. In that case, in each random walk, a vector which represents whether a walker has passed through each vertex by using “1” and “0” is created, and one-class SVM will be applied to this vector set.

Furthermore, other than a Jaccard coefficient, a Dice coefficient or a Simpson coefficient etc. may be used.

(f5: Sorting as Community)

Hereinafter, a process for sorting as a community in step S89 of FIG. 9 will be described.

The above described similarities between random walks (i.e., a Jaccard coefficient and a COS similarity) are all normalized and will be a real number between 0 and 1. What has a similarity between random walks which is equal to or greater than a predetermined threshold value is determined as belonging to a single community and a starting vertex of each random walk is sorted into the same single community.

The above described similarity between random walks evaluates a similarity between two random walks, and a similarity between a particular random walk and another random walk and a similarity between that particular random walk and still another random walk may not be consistent. In such a case, if there is a connection with any of the random walks, sorting into the same community may be done. More specifically, for example, it is assumed that a similarity between random walks for vertices v1 and v2 is calculated and as a result it is determined that these vertices belong to the same community and a similarity between random walks for vertices v2 and v3 is calculated and as a result it is determined that these vertices belong to the same community. In such a case, if a similarity regarding vertices v1 and v3 is less than the threshold value and accordingly it is determined that they do not belong to the same community, a relationship of vertices v1 and v3 with vertex v2 may be considered to determine that vertices v1, v2 and v3 all belong to the same community.

The threshold value for evaluating a similarity can be set as desired. In other words, by adjusting a threshold value used to evaluate a similarity between random walks, as desired, a strength of a connection required to be detected as a single community can be adjusted intuitively. More specifically, the threshold value for evaluating a similarity can for example be set to “0.4.” Note, however, that a user may be allowed to adjust the threshold value interactively with reference to a result of the community structure detection process.

When the community structure detection process according to the present embodiment is applied to image clustering for a large number of images, the images include input images in which although the same subject is photographed it is photographed under different conditions such as a different season, a different time zone, a different perspective, a different angle, etc. In such a match graph as shown in FIGS. 5A and 5B, a connection between input images obtained under the same or a similar photographing condition such as in the same or a similar season tends to be dense, whereas a connection between input images obtained under different photographing conditions tends to be sparse even when the input images have the same subject.

Accordingly, by interactively adjusting a threshold value for determining the same community's range, even when the same subject is photographed, a plurality of input images thereof obtained under different photographing conditions such as in different seasons may be included in the same community or separated into different communities, depending on the purpose of the clustering, etc.

### G. Application to Weighted Graph

While in the above description there is no limitation on a weight of an edge included in a match graph, the present invention is also applicable to a weighted graph having each edge weighted. In a case where a weighted graph is generated, for example, in the above described image matching process, depending on the number of corresponding feature points found, the image matching process's reliability, etc., a weight may be set for an edge which connects a vertex and another vertex. More specifically, a match graph may have an edge weighted in accordance with a degree of matching between two vertices connected thereby.

In a random walk, when a walker is located at a vertex, weights provided to edges, respectively, selectable from that vertex are reflected, and an edge to be followed is then determined stochastically. That is, a destination of a transition is stochastically determined based on a weight set for each edge connected to each vertex.

For example when weights w1, w2 and w3 are set for three edges, respectively, connected to vertex A, a probability of a transition to the edge for which weight w1 is set will be w1/(w1+w2+w3). When the community structure detection process according to the present embodiment is applied to a weighted graph, then, except for a process for stochastically determining a destination of a transition, a process similar to the above described process may be performed.

### H. Result of Experiment

Hereinafter, an example of a result of an experiment evaluating a clustering performance by the image clustering system according to the present embodiment will be described.

(h1: Methodology of Experiment)

As subjects, Todai-ji Temple, Nikko Tosho-gu Shrine, and Horyu-ji Temple were assumed and Creative Commons licensed images thereof were collected. More specifically, for Todai-ji Temple, 4,015 images retrieved by inputting “todaiji” as a search term were used. For Nikko Tosho-gu Shrine, 3,808 images retrieved by inputting “toshogu” as a search term were used. For Horyu-ji Temple, 1,102 images retrieved by inputting “horyuji” as a search term were used.

And in accordance with the method disclosed in “Building Rome in a day” described above, a portion of the collected images (500 Todai-ji Temple images, 500 Nikko Tosho-gu Shrine images, and 200 Horyu-ji Temple images) was used to learn a vocabulary tree (see “Building Rome in a day” above), and this vocabulary tree was used to generate a match graph for each subject. The match graph of Todai-ji Temple included 3,515 vertices, the match graph of Nikko Tosho-gu Shrine included 3,308 vertices, and the match graph of Horyu-ji Temple included 902 vertices.

Some methods including the community structure detection method according to the present embodiment were applied to these three types of match graphs. For example, images associated with Todai-ji Temple include images of the Great Buddha Hall, Chu-mon Gate, Wooden Deva king statues (Ungyo statue and Agyo statue), Birushana Buddha statue (Great Buddha), Kokuzo Bosatsu statue, Nandai-mon Gate, etc., and a performance of clustering these subjects was evaluated.

Although the generated match graphs will be directed graphs, they are also regarded as undirected graphs and thus evaluated. Each experimental condition is as follows:

### Example 1 (Directed Graph)

The generated match graphs (directed graphs) were subjected to community structure detection in accordance with the flowchart shown in FIG. 9 (prescribed trial number of times: 100, prescribed ratio of abnormal value exclusion process: 0.2, and similarity evaluating threshold value: 0.4.).

### Example 2 (One-Way Undirected Graph)

When a generated match graph (a directed graph) has an edge from a vertex to another vertex in any one direction, then, the vertices are connected by an undirected edge, rather than a directed edge, to generate an undirected graph. Each connected component of the generated undirected graph is regarded as a cluster.

### Example 3 (Two-Way Undirected Graph)

Only when a generated match graph (a directed graph) has a connection from a vertex to another vertex in both directions, the vertices are connected by an undirected edge, rather than a directed edge, to generate an undirected graph. Each connected component of the generated undirected graph is regarded as a cluster.

### Example 4 (Spin Glass)

The generated match graphs (directed graphs) were subjected to community structure detection in accordance with a method disclosed in “Statistical mechanics of community detection,” J. Reichardtand S. Bornholdt, Physical Review E, Vol. 74, 2006 (the “Spin glass” method).

### Example 5 (Infomap)

The generated match graphs (directed graphs) were subjected to community structure detection in accordance with a method disclosed in “The map equation,” M. Rosvall and C. T. Bergstrom, The European Physical Journal Special Topics, Vol. 178, pp. 13-23, 2009 (the “Infomap” method).

(h2: Result of Experiment)

As evaluation indices, three indices, i.e., Global Purity, Inverse Purity, and F-measure, were used. Global Purity is a weighted average of a ratio of elements belonging to a largest number of classes in each detected community, and a larger value thereof means that a ratio at which an element belonging to another class (i.e., a noise) is mixed is low. Inverse Purity is a weighted average of a ratio of elements defined with each label in each cluster (or community). F-measure is a harmonic mean of Global Purity and Inverse Purity.

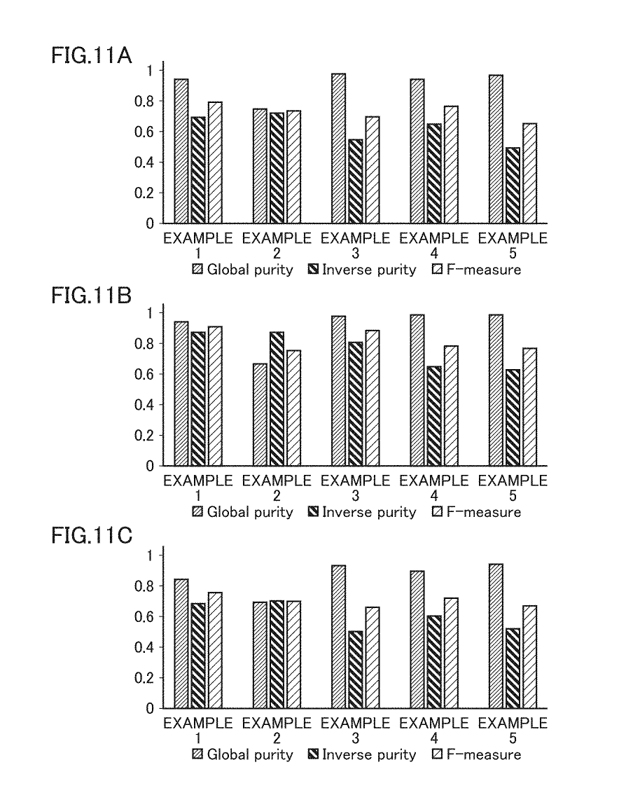

FIGS. 11A-11C show an example of a result of an experiment for an evaluation in performance of the community structure detection method according to the present embodiment. FIG. 11A shows an example of a result of an experiment for a match graph for Todai-ji Temple, FIG. 11B shows an example of a result of an experiment for a match graph for Nikko Tosho-gu Shrine, and FIG. 11C shows an example of a result of an experiment for a match graph for Horyu-ji Temple.

As shown in FIGS. 11A-11C, by applying the community structure detection method according to the present embodiment to a match graph (a directed graph) (see example 1), an F-measure higher than those of the other methods (see examples 2-5) was able to be obtained. In other words, it can be said that generating a match graph reflecting a result of a process of matching input images included in an input image group, and applying the community structure detection method to the match graph to detect a community allow sufficiently practical image clustering to be implemented. And it can be said that among community structure detection methods, the community structure detection method according to the present embodiment as described above allows higher clustering accuracy to be obtained.

### I. Exemplary Application

Hereinafter will be illustrated some systems to which the community structure detection method according to the present embodiment is applied.

(i1: Automatic Labeling System)

An automatic labeling system for images will be described as an example of applying the community structure detection method according to the present embodiment.

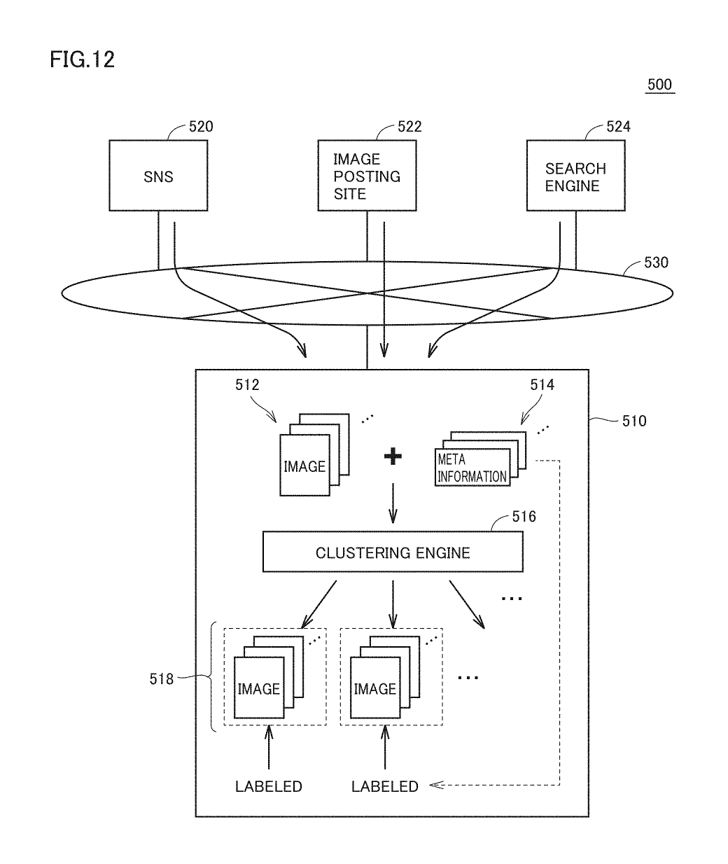

With reference to FIG. 12, an automatic labeling system 500 includes a server device 510 which performs a process of the community structure detection method according to the present embodiment etc.

Server device 510 is configured to be capable of communicating data via a network 530 with an SNS (Social Network Service) server device 520, an image posting site server device 522, a search engine 524, etc. Server device 510 collects any images 512 from SNS server device 520, image posting site server device 522, search engine 524, etc. and sorts these collected images 512 for each different subject (or determines a community), and also labels a cluster (or community) obtained through the sorting.

Specifically, server device 510 has a clustering engine 516, and clustering engine 516 subjects collected images 512 to image clustering shown in FIG. 2. Thus a cluster (or community) 518 assumed to have photographed the same subject included in images 512 is determined.

When meta information such as a photographing date and time, a photographing location, and comments is provided to image 512, meta information 514 of these is also collected. Based on the collected meta information, server device 510 labels cluster 518 determined.

Thus, cluster 518 labeled will include an image obtained by photographing a subject indicated by the label.

Automatic labeling system 500 as described above facilitates an operation of clustering a large amount of images for each subject photographed therein. Such clustering is beneficial for a visual guidance of a tourist site for example.

(i2: Image Searching System)

An image database generated by automatic labeling system 500 as shown in FIG. 12 can also be used to provide an image searching system.

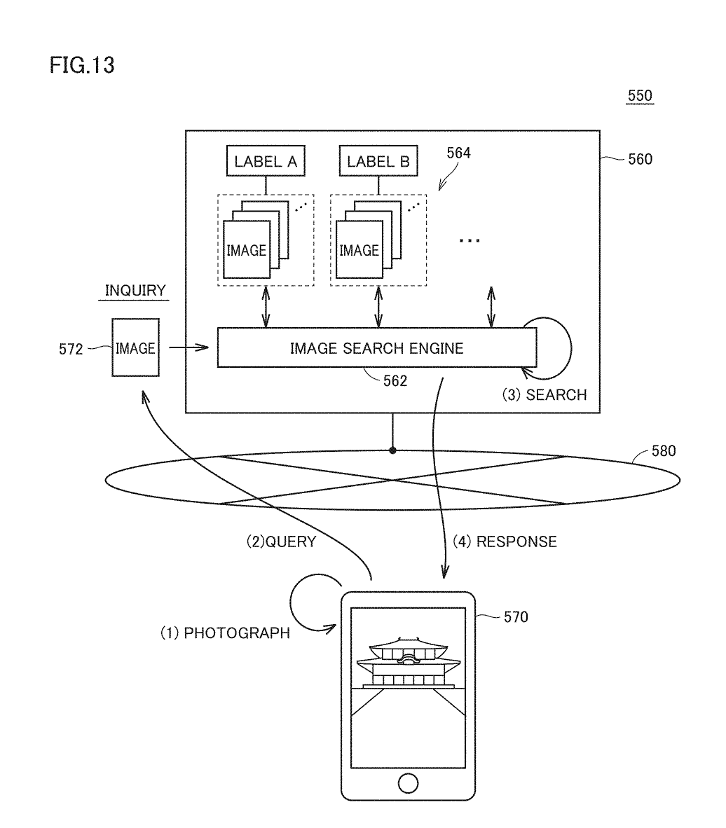

FIG. 13 shows an example in configuration of an image searching system using the community structure detection method according to the present embodiment. With reference to FIG. 13, an image searching system 550 includes a server device 560 accessible from a terminal device 570 via a network 580.

For example, terminal device 570 is a portable device such as a smart phone or a tablet, and when the user visits any of sites for sightseeing, the user photographs some subject and transmits a photographed image 572 to server device 560 for the sake of illustration.

When query image 572 from terminal device 570 is received by server device 560, an image search engine 562 of server device 560 refers to a previously prepared image database 564 to search for an image matching the image via which a query is received. Image database 564 has a plurality of images clustered therein for each subject, and each cluster is provided with a label indicating a subject.

When image search engine 562 finds an image in image database 564 that matches input image 572, image search engine 562 responds to terminal device 570 with a label provided to the found image and information associated with that label. For example, the response may be done with information such as a history associated with the subject of image 572. Thus, when image search engine 562 externally receives an image which is a target of a query, image search engine 562 searches through a set of input images included in each cluster for an input image corresponding to the received image and also responds with information of a cluster to which the corresponding input image belongs (i.e., a label, associated information, etc.).

By using image searching system 550 as described above, an automatic guidance at a tourist site can be provided. A service may be provided in which, in response to a tourist transmitting to server device 560 an image of some object photographed at a site which the tourist visits, what name the object of the subject has, its history, another image thereof photographed in a different season or at a different angle, etc. are displayed.

(i3: Others)

The systems shown in FIG. 12 and FIG. 13 are only a portion of an example of applying the community structure detection method according to the present embodiment and they are not exclusive. The community structure detection method according to the present embodiment is applicable to anything that can represent a connection between elements in the form of a graph.

### J. Advantages

According to the image clustering system according to the present embodiment, by applying a community structure detection method to a match graph reflecting a result of a process of matching input images included in an input image group, even a set of unlabeled input images can automatically be sorted for each subject.

According to the community structure detection method according to the present embodiment, a community in a graph (typically, a match graph) is determined based on a similarity among passage histories each obtained by a random walk done for the graph with each vertex serving as a starting point. A value indicating how passage histories are similar (i.e., a similarity) can be calculated as a normalized specific numerical value, and handling of similarity is intuitively, easily understandable. In other words, by setting a threshold value etc. for the calculated similarity, as desired, a strength of a connection required to be detected as a community can be adjusted as desired. As such a strength of a connection can be adjusted as desired, an interactive adjustment can be done with reference to a result of detecting a community structure, so that a more preferable detection result is obtained depending on the target data set.

Furthermore, according to the community structure detection method according to the present embodiment, with reference to a result of a community structure detecting process, a prescribed number of steps and a prescribed trial number of times involved in performing a random walk can be interactively adjusted. This allows adjustment to be done as desired to provide a more preferable detection result depending on the target data set.

Furthermore, the community structure detection method according to the present embodiment is applicable to any of an undirected graph and a directed graph, and is further applicable to a weighted graph. Accordingly, it is applicable to any match graph as long as a method of association corresponding to a target data set can be adopted to create the match graph. In other words, a significantly versatile, novel community structure detection method can be implemented.

While the present invention has been described in embodiments, it should be understood that the embodiments disclosed herein are illustrative and non-restrictive in any respect. The scope of the present invention is defined by the terms of the claims, and is intended to include any modifications within the meaning and scope equivalent to the terms of the claims.

What is claimed is:

1. An image clustering system comprising:
an obtaining module configured to obtain a match graph reflecting a result of an image matching process of matching input images included in an input image group, the match graph including a vertex corresponding to each of input images and an edge connecting vertices corresponding to input images determined to match each other;
a community structure detection module configured to associate input images with each other, based on the match graph's structure; and
an output module configured to output as a cluster a set of the associated input images.

2. The image clustering system according to claim 1, wherein the community structure detection module comprises:
a trial module configured to set each vertex included in the match graph as a starting point and make a successive movement within the match graph by a prescribed number of steps while stochastically selecting a connected edge, to obtain a passage history regarding the movement; and
an association module configured to determine passage histories associated with each other based on a similarity among the obtained passage histories in which each vertex is set as the starting point, and associate input images with each other which respectively correspond to the starting points of the associated passage histories.

3. The image clustering system according to claim 2, wherein:
the trial module repeats the successive movement within the match graph by a prescribed number of steps, with a single vertex serving as a starting point, a prescribed trial number of times; and
the community structure detection module further includes an exclusion module configured to exclude a vertex having a statistical abnormal value from a plurality of passage histories in which a same vertex is set as the starting point.

4. The image clustering system according to claim 3, wherein the exclusion module couples together a plurality of passage histories in which a same vertex is set as the starting point and regards a vertex in the coupled passage histories having a relatively small passage frequency such that the vertex is not included in the passage histories.

5. The image clustering system according to claim 4, wherein in response to determination that a first input image serving as a reference image and a second input image serving as a target image match in the image matching process, in the match graph, an edge is provided from a vertex corresponding to the first input image toward a vertex corresponding to the second input image.

6. The image clustering system according to claim 5, wherein when a vertex without an edge allowing the movement to another vertex is reached before the movement by the prescribed number of steps is completed, the trial module terminates a process for obtaining the passage history.

7. The image clustering system according to claim 1, further comprising an image matching module configured to perform as the image matching process a process to search for a corresponding feature point between input images.

8. The image clustering system according to claim 2, wherein:
the match graph has an edge weighted in accordance with a degree of connection between two vertices connected thereby; and
the trial module reflects a weight provided to each selectable edge and then stochastically determines an edge to be followed for a further movement.

9. The image clustering system according to claim 1, further comprising a searching module configured such that, upon externally receiving an image which is a target of a query, the searching module searches through a set of input images included in each cluster for an input image corresponding to the received image and responds with information of a cluster to which the corresponding input image belongs.

10. An image clustering method comprising:
obtaining a match graph reflecting a result of an image matching process of matching input images included in an input image group, the match graph including a vertex corresponding to each of input images and an edge connecting vertices corresponding to input images determined to match each other;
associating input images with each other, based on the match graph's structure; and
outputting as a cluster a set of the associated input images.

11. The image clustering method according to claim 10, wherein the associating includes:
setting each vertex included in the match graph as a starting point and making a successive movement within the match graph by a prescribed number of steps while stochastically selecting a connected edge, to obtain a passage history regarding the movement; and
determining passage histories associated with each other based on a similarity among the obtained passage histories in which each vertex is set as a starting point, and associating input images with each other which respectively correspond to the starting points of the associated passage histories.

12. The image clustering method according to claim 10, further comprising, upon externally receiving an image which is a target of a query, searching through a set of input images included in each cluster for an input image corresponding to the received image, and responding with information of a cluster to which the corresponding input image belongs.

13. A non-transitory storage medium storing thereon a computer-readable image clustering program, the image clustering program causing a computer to perform:
obtaining a match graph reflecting a result of an image matching process of matching input images included in an input image group, the match graph including a vertex corresponding to each of input images and an edge connecting vertices corresponding to input images determined to match each other;
associating input images with each other, based on the match graph's structure; and
outputting as a cluster a set of the associated input images.

14. The non-transitory storage medium according to claim 13, wherein the associating includes:
setting each vertex included in the match graph as a starting point and making a successive movement within the match graph by a prescribed number of steps while stochastically selecting a connected edge, to obtain a passage history regarding the movement; and
determining passage histories associated with each other based on a similarity among the obtained passage histories in which each vertex is set as a starting point, and associating input images with each other which respectively correspond to the starting points of the associated passage histories.

15. The non-transitory storage medium according to claim 13, further comprising, upon externally receiving an image which is a target of a query, searching through a set of input images included in each cluster for an input image corresponding to the received image, and responding with information of a cluster to which the corresponding input image belongs.

16. A community structure detection system comprising:
an obtaining module configured to obtain a graph including a plurality of vertices and an edge connecting vertices;
a trial module configured to set each vertex included in the graph as a starting point and make a successive movement within the graph by a prescribed number of steps while stochastically selecting a connected edge, to obtain a passage history regarding the movement;
an association module configured to determine passage histories associated with each other based on a similarity among the obtained passage histories in which each vertex is set as a starting point, and associate vertices that are set as the starting points of the associated passage histories; and
an output module configured to output as a cluster a set of the associated vertices.
